(19) United States
(12) Patent Application Publication
(10) Pub. No.: US 2003/0193837 A1
(43) Pub. Date: Oct. 16, 2003

(54) Processing seismic data

(75) Inventor: Bjorn Eino Rommel, Caldecote (GB)

Correspondence Address: Intellectual Property Law Department, Schlumberger-Doll Research, 36 Old Quarry Road, Ridgefield, CT, 06877-4108, US

(73) Assignee: WESTERNGECO L.L.C., A Delaware Limited Liability Company, Houston, TX

(21) Appl. No.: 10/376,076

(22) Filed: Feb. 27, 2003

(30) Foreign Application Priority Data
Apr. 10, 2002 (GB) 0208292.3

(51) Int. Cl. G01V 1/00

(52) U.S. Cl. 367/37

(57) ABSTRACT

A method of evaluating a seismic survey to be carried out at a particular survey location comprises choosing an initial seismic surveying arrangement. One or more parameters of AVO (amplitude versus offset) uncertainty are then determined from the seismic surveying arrangement using a model of the earth's interior at the survey location. If the parameter(s) of AVO uncertainty are not acceptable the seismic surveying arrangement is changed, and the AVO uncertainty parameter(s) re-determined for the new acquisition geometry.

The determination of the AVO uncertainty parameter(s) may make use of prior information such as the noise covariance and/or model covariance. This enables the AVO uncertainty parameters to be estimated independent of any seismic data.

The present invention relates to method of processing seismic data, in particular to a method of and apparatus for determining AVO (amplitude versus offset) uncertainty.

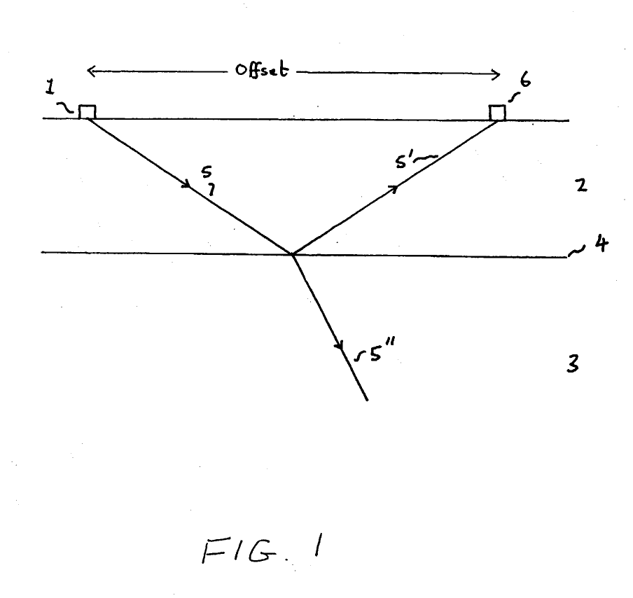

FIG. 1 is a schematic illustration of a seismic survey, in which seismic energy emitted by a seismic source 1 radiates into the earth's interior. The earth's interior is not uniform but contains layers or regions having different seismic properties. The earth's internal structure is schematically represented in FIG. 1 as two horizontal layers 2, 3 separated by an interface 4. FIG. 1 shows one seismic energy path 5, in which seismic energy propagates downwardly into the earth until it is incident on the interface 4. Since the seismic properties of the layer 2 above the interface 4 differ from those of the layer 3 below the interface 4, the interface acts as a partial reflector of seismic energy. Some of the energy incident on the interface 4 along the path 5 will be reflected upwards along path 5′ and will propagate to the earth's surface and eventually be incident on a seismic energy sensor 6 located on the earth's surface. (The sensor 6 will hereinafter be referred to as a “receiver”, as is customary in the field of seismic surveying.)

Seismic energy that is not reflected along the path 5′ will be transmitted through the interface, and will continue to propagate downwardly further into the earth' interior along path 5″.

In practice the earth's interior contains a large number of structures that act as partial reflectors of seismic energy. When the source 1 is actuated to emit a pulse of seismic energy, the energy acquired at the receiver 6 will contain “events” arising from reflection at a number of different reflectors within the earth.

The travel time of seismic energy from the source 1 to the receiver 6 along a path involving reflection within the earth's interior will depend on, inter alia, the horizontal distance between the source 1 and the receiver 6. The horizontal distance between the source 1 and the receiver 6 is generally known as “offset”. It is well-known in seismic surveying to derive information about the earth's structure from the variation with offset of travel time from the source to the receiver. However, as the source-receiver offset varies the amplitude of the energy received at the receiver along a particular reflection path—for example the path involving reflection at the interface 4—will also vary. This variation in amplitude of the acquired seismic energy occurs because a change in source-receiver offset changes the angle of incidence that the seismic energy makes with the interface 4, and this change in angle of incidence alters the ratio between the amplitude of seismic energy transmitted along path 5′ and the amplitude of seismic energy reflected along path 5″. It is possible to derive further information about the earth's interior from analysis of the variation of amplitude of acquired seismic energy with offset, and this process is known as “AVO inversion”. AVO inversion provides information about the difference in elasticity or impedance or velocity and density across an interface within the earth. The differences in elasticity or impedance or velocity and density are therefore known as “AVO parameters”. In the present application, the term “AVO uncertainty” will be understood as comprising all distributions of possible AVO parameters that are consistent with a seismic surveying arrangement.

AVO inversion takes into account the fact that the seismic data acquired at a receiver will include noise, and so are inconsistent and inaccurate. It may also take into account the fact that some prior information about the data and/or the model of the earth's interior may be available.

Notably, linearised AVO inversion may be calculated as follows:

d=Wm+n (1)

where d represents the seismic data acquired at a receiver, W is the earth's response (or, in mathematical terms, a forward operator), m is the correct model of the earth's interior, and n is noise. (In the simplified case shown in FIG. 1, the earth model m would relate to the changes in elasticity and density of the earth across the interface 4.) The true earth model m is unknown, and the intent of AVO inversion is to determine the true earth model m from the acquired data d.

It is possible to define an inverse operator H that obtains an observed earth model m_{obs} (which may not necessarily be the true earth model m) from the data d, as:

m_{obs}=Hd (2)

The inverse operator H is given by:

$$H = {CW}^{T} {C}_{n}^{- 1} \qquad ( 3 )$$

where

$$C = {( {W}^{T} {C}_{n}^{- 1} W + {C}_{m}^{- 1} )}^{- 1} \qquad ( 4 )$$

In equations (3) and (4), C is the posterior covariance (or covariance of the estimation error), Cₙ is the covariance of the noise, Cₘ is the covariance of the earth model, and the suffix T denotes the transpose operator.

It is further possible to define the resolution R, as:

R=HW (5)

The resolution R characterises the accuracy of mapping the true earth model m onto the observed earth model m_{obs} derived from the data d, as:

m_{obs}=Hd=Rm (6)

Finally, if a prior earth model mₚᵣᵢₒᵣ existed before the start of the AVO inversion process, it is possible to define a posterior earth model mₚₒₛₜ in terms of the earth model observed from the AVO inversion m_{obs} and the earth model mₚᵣᵢₒᵣ existing before the AVO inversion process, using:

mₚₒₛₜ=m_{obs}+(I−R)mₚᵣᵢₒᵣ (7)

where I is the identity operator.

The resolution R and the posterior covariance C are measures of the uncertainty in the results of the AVO inversion process. Thus, not only can AVO inversion provide an estimate of the change in elasticity and density across an interface, but it also can provide information about the likely error in this estimate.

Non-linearised AVO inversion may also be calculated according to methods known from the state of the art. Such methods also permit the calculation of AVO Uncertainty.

The basic principles of AVO inversion have been described by a number of workers, for example by G. E. Backus and J. F. Gilbert in “Numerical Applications of a formalism for Geophysical Inverse Problems”, Geophysics Journal of the Royal Astronomical Society, Vol. 13, pp 247-276 (1967) and in “The Resolving Power of Gross Earth Data”, Geophysics Journal of the Royal Astronomical Society, Vol. 16 pp 169-205 (1968), by D. D. Jackson in “Interpretation of Inaccurate, Insufficient and Inconsistent Data”, Journal of the Royal Astronomical Society, Vol. 28, pp 97-109 (1972) and in “The Use of A Priori Data to resolve non-uniqueness in Linear Inversion”, Geophysics Journal of the Royal Astronomical Society, Vol. 57, pp 137-157 (1979), and by A. Tarantola and B. Valette in “Inverse Problem=Quest for Information”, Journal of Geophysics, Vol. 50, pp 159-170 (1982).

AVO inversion is commonly done for the intercept and gradient of the amplitude-versus-offset curve. AVO inversion directly for the AVO parameters has been proposed by A. de Nicolao et al. in “Eigenvalues and Eigenvectors of Linearised Elastic Inversion”, Geophysics, Vol. 58. 670-679 (1993). However, AVO inversion direct for the AVO parameters is generally an ill-posed problem (that is, it is a problem that does not have a unique solution), and so is rarely done in practice.

G. Lörtzer and A. J. Berkhout have proposed, in “Linearised AVO inversion of Multicomponent Seismic data”, in J. P Castagna and M. M. Backus “Offset-Dependent Reflectivity—Theory and Practice of AVO Analysis”, Investigation in Geophysics No. 8, published by Society of Exploration Geophysicists (1993), that the noise covariance Cₙ and the model covariance Cₘ can be considered as prior information, whereas de Nicholao et al. (supra) considered these to be information that is deduced from the data after AVO inversion. Taking the noise covariance Cₙ and the model covariance Cₘ as prior information means that the prior information is not zero but is finite, and this transforms the AVO inversion from an ill-posed problem to a well-posed problem.

In order to take the noise covariance Cₙ and the model covariance Cₘ as prior information it is necessary to estimate these quantities from information other than the seismic data d. The model covariance may be estimated from, for example borehole seismic data or vertical seismic profile (VSP) seismic data covering the survey location, or from petrophysical assumptions about the survey location. The noise covariance may be estimated from, for example, assumptions about random noise in the data d, and these assumptions can be based on other data acquired at the survey location provided that the earlier data are sufficiently oversampled to allow separation of the data into their signal and noise components, for example according to the method disclosed in co-pending UK patent application No 0114744.6.

A first aspect of the present invention provides a method of evaluating a seismic survey, the method comprising the steps of

a) defining a seismic surveying arrangement; and

b) determining one or more parameters of AVO uncertainty from the seismic surveying arrangement at a survey location from a model of the earth's interior at the survey location.

A second aspect of the present invention provides an apparatus for evaluating a seismic surveying arrangement, the apparatus comprising means for determining one or more parameters of AVO uncertainty from the seismic surveying arrangement at a survey location from a model of the earth's interior at the survey location.

The apparatus may comprise a programmable data processor.

A third aspect of the present invention provides a storage medium containing a program for controlling the data processor of an apparatus as defined above.

A fourth aspect of the present invention provides a storage medium containing a program for controlling a data processor to perform a method as defined above.

Preferred embodiments of the invention will now be described by way of illustrative examples with reference to the accompanying figures in which:

FIG. 1 is a schematic view of a seismic surveying arrangement;

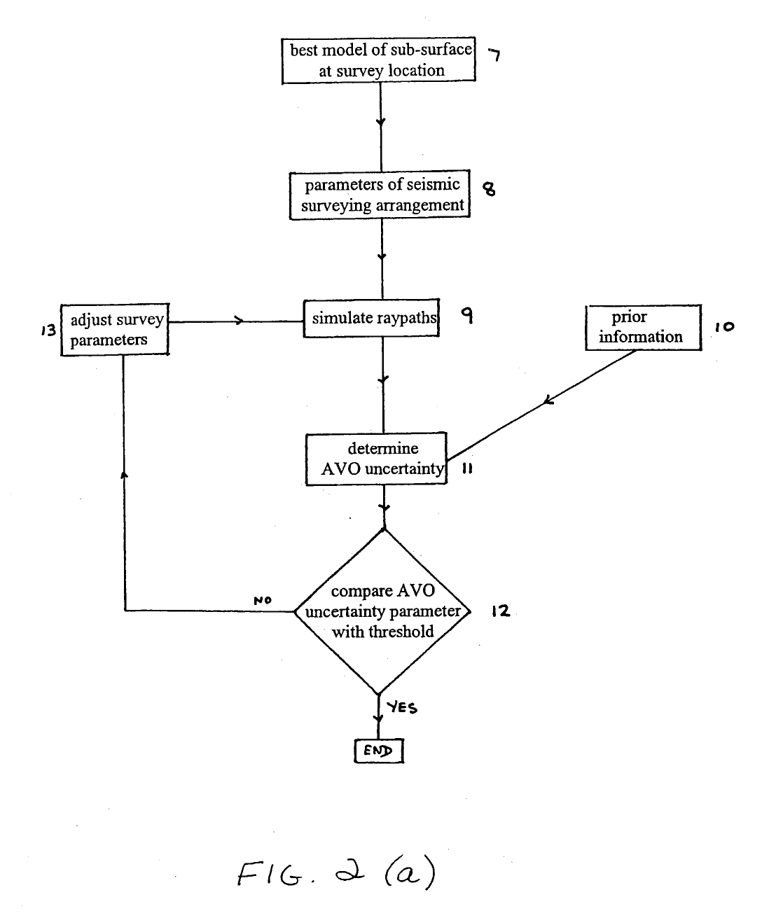

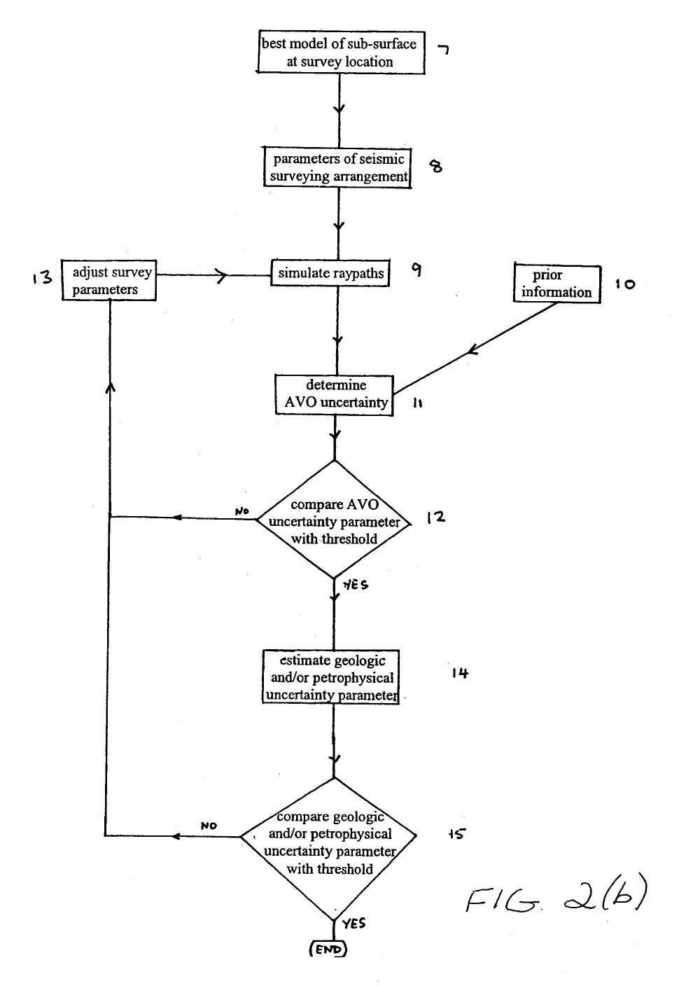

FIG. 2(a) is a block flow diagram of a method according to the present invention;

FIG. 2(b) is a block flow diagram of another method according to the present invention;

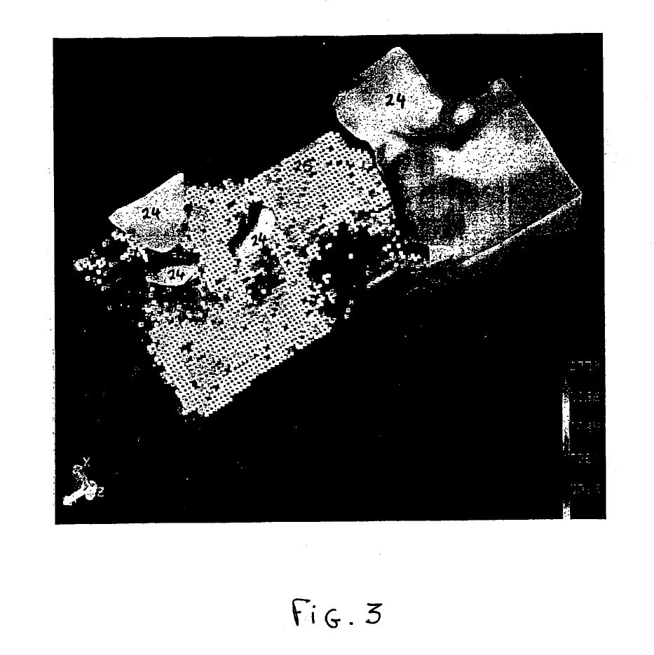

FIG. 3 illustrates output data from a method of the present invention;

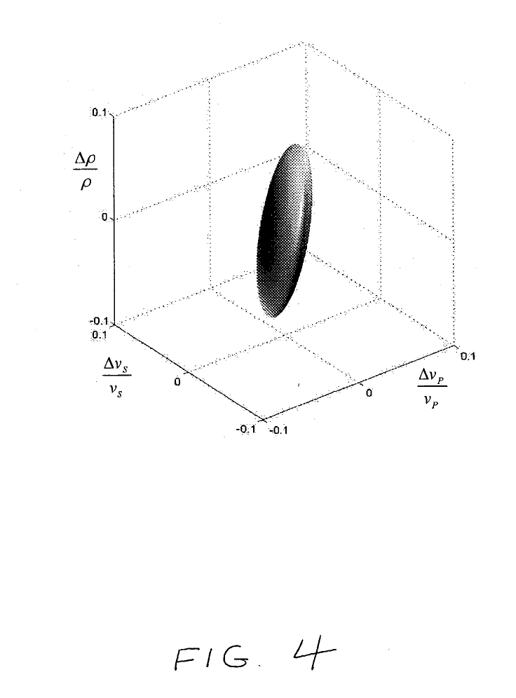

FIG. 4 illustrates alternative output data from a method of the present invention;

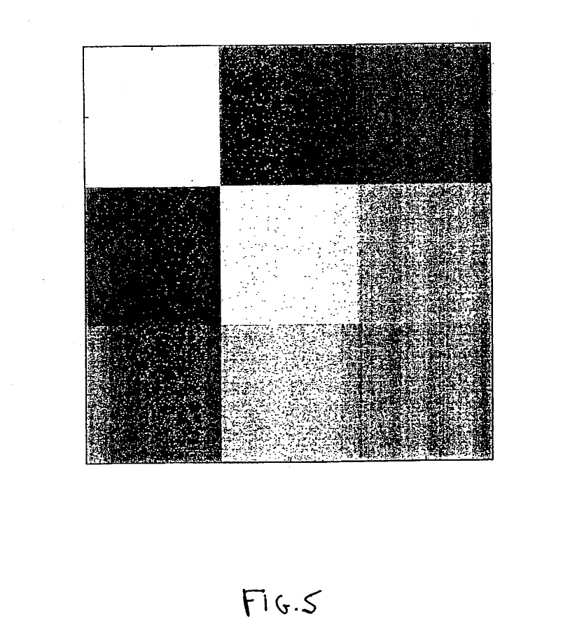

FIG. 5 illustrates alternative output data from a method of the present invention; and

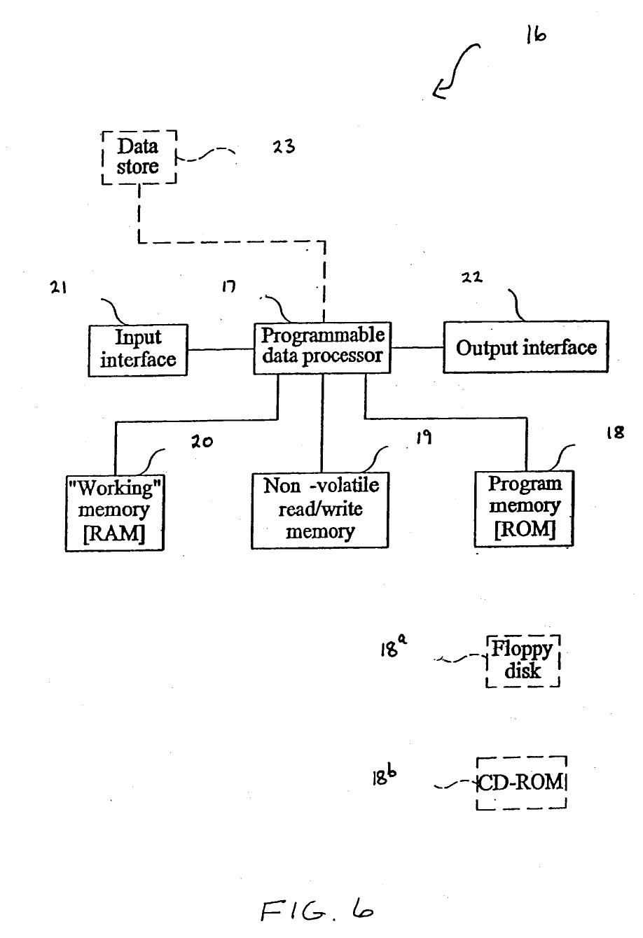

FIG. 6 is a block schematic flow diagram of an apparatus according to the present invention.

The present invention makes use of the fact that, if the noise covariance and the model covariance are prior information and so are independent of the seismic data d, the posterior covariance and resolution for a seismic surveying arrangement at a survey location are also independent of the seismic data d. The posterior covariance C can be determined from the noise covariance Cₙ and the model covariance Cₘ using equation (4), since W is also known so, if the noise covariance Cₙ and the model covariance Cₘ are prior information independent of the seismic data d, the posterior covariance is also independent of the seismic data. Moreover the resolution R may be found once the posterior covariance C has been determined using:

$$R = HW = ( {CW}^{T} {C}_{n}^{- 1} ) W \qquad ( 8 )$$

Thus, once the noise covariance and the model covariance are assumed to be prior information, the posterior covariance and the resolution are seen to be wholly independent of the acquired seismic data d—and so may be estimated even in the absence of any seismic data. The present invention makes use of this during the SED phase (Survey Evaluation and Design phase) of a seismic survey to predict the posterior covariance and/or resolution that a particular seismic surveying arrangement (or “acquisition geometry”) will provide at the survey location. Since the posterior covariance and resolution are measures of uncertainty or error in the estimate of the AVO parameters obtained by AVO inversion of data acquired in a survey, and are independent of the seismic data d, the present invention makes it possible to predict in advance whether a proposed seismic surveying arrangement will allow the AVO parameters to be estimated with an acceptable error level. The posterior covariance and resolution may be estimated by computing raypaths and angles of incidence of seismic energy for a proposed seismic surveying arrangement.

As noted above, Lörtzer et al. (supra) have proposed that the noise covariance and the model covariance can be regarded as prior information that is available during the AVO inversion process. However, they did not realise that this allows the posterior covariance and resolution to be regarded as information that is independent of the acquired seismic data.

FIG. 2(a) is a schematic flow diagram illustrating the principal steps of a method of evaluating a seismic survey according to the present invention.

Initially, at step 7, the best model of the geologic structure and seismic properties of the earth's interior is made for a desired survey location. The model is constructed using the best available information about the survey location, for example information that has been obtained in previous seismic surveys at the survey location.

At step 8 the parameters of a seismic surveying arrangement (or “acquisition geometry”) are defined. The parameters of the seismic surveying arrangement may include, for example, the following:

number of seismic sources;

details of the source array such as the arrangement of the sources and the separation between two adjacent sources (if there is more than one seismic source);

the number of seismic receivers;

details of the source array such as the arrangement of the receivers and the separation between adjacent receivers (if there is more than one seismic receiver); and

the separation between the source or source array and the receiver or receiver array.

Next, at step 9, one or more raypaths of seismic energy are simulated. That is, step 9 simulates one or more raypaths that would be obtained if the seismic surveying arrangement defined in step 8 were used to carry out a seismic survey at the survey location, in the light of the best model of the seismic properties of earth's interior at the survey location as defined at step 7.

The simulation of raypaths of seismic energy is a known step in the SED phase of a seismic survey, and will not be described in detail here. In outline, however, step 9 may consist of using ray tracing to evaluate the propagation of the seismic wavefield produced by the source array of the seismic surveying arrangement defined at step 8 through the model of the survey location defined at step 7. This will allow the raypaths incident on the receiver array of'the seismic surveying arrangement defined at step 8 to be determined.

It should be noted that the present invention does not require a simulation of the amplitude of the seismic energy incident on the receivers of the seismic surveying arrangement. It is sufficient for step 9 to simulate the raypaths of the seismic energy—that is, for step 9 to consist of a kinematic simulation of the seismic data—and it is not necessary to perform a full dynamic simulation that also simulates the amplitude of the seismic data (although in principle a full simulation could be carried out at step 9).

At step 10, prior information is input, as will be discussed below.

At step 11, the AVO uncertainty is determined from the one or more simulated raypaths obtained at step 9. Determining AVO uncertainty on simulated seismic data, for example in the SED phase of a seismic survey, is again known and so will not be described in detail here. In outline, however, the simulated raypath(s) acquired at step 9 are sorted into CDP (common depth point) gathers, and, together with the CDP sorting, the respective angles of incidence of the rays are recorded. This provides all information necessary to determine AVO uncertainty on each CDP gather.

It should be noted that it is not necessary to perform a full AVO inversion at step 11 to determine the AVO uncertainty parameters. Indeed it may not be possible to perform a full AVO inversion at step 11 since it is necessary to have full seismic data including amplitude data in order to perform a full AVO inversion. If step 9 consists only of simulating raypaths of seismic energy then it is not possible to carry out a full AVO inversion at step 11. (In principle it would be possible to perform a full simulation of seismic data, including amplitude, at step 9 and perform a full AVO inversion at step 11, but the invention does not require this.)

In accordance with the present invention, the raypaths simulated at step 9 are not the only input to step 11. The present invention also makes use of the prior information input at step 10, to arrive at the best solution.

Step 10 may consist of estimating both of the noise covariance Cₙ and the model covariance Cₘ. The model covariance may be estimated from, for example, pre-existing borehole seismic data or VSP seismic data available for the survey location, or from petro-physical assumptions about the survey location. The noise covariance may be estimated from, for example, assumptions about random noise in the data d, and these assumptions may be based on other seismic data acquired at the survey location provided that the earlier data are sufficiently over sampled to allow the noise component to be identified.

The output of step 11 is one or more parameters of AVO uncertainty for the seismic surveying arrangement defined at step 8 at the survey location as modelled by the model chosen at step 7. The parameters of the AVO uncertainty output from step 11 may comprise the resolution, the posterior covariance, or both the resolution and the posterior covariance. Steps 7-11 of the method shown in FIG. 2(a) therefore allow one or more parameters of AVO uncertainty, such as the resolution and/or posterior covariance, to be predicted at the SED phase of the seismic survey.

In practice, when a seismic survey arrangement is designed there will be a desired threshold for the AVO uncertainty of the seismic data that the survey will acquire. The method of the present invention therefore preferably includes the step of comparing the value of the or each parameter of AVO uncertainty output at step 11 with a respective pre-determined threshold. In general, the threshold will represent a maximum allowable value for the AVO uncertainty parameter, and step 12 will determine whether the threshold for the or each parameter is exceeded.

If step 12 results in a determination that the prescribed threshold(s) is/are not satisfied, one or more of the parameters of the seismic surveying arrangement are modified at step 13. Steps 9, 11 and 12 are then repeated for the modified seismic surveying arrangement, and steps 13, 9, 11, 12 are repeated until a “yes” determination is obtained at step 12.

In a preferred embodiment in which more than one parameter of AVO uncertainty is output at step 11, step 12 consists of comparing each parameter with a respective pre-determined threshold. For example, if the posterior covariance and the resolution are obtained at step 11, step 12 would consist of comparing the resolution with a pre-determined threshold for the resolution, and also comparing the posterior covariance with a pre-determined threshold for the posterior covariance. A “yes” determination would be obtained if both the resolution and the posterior covariance compared satisfactorily with their respective threshold, otherwise a “no” determination would be obtained and the method would then move on to the step 13 of adjusting the survey parameters and repeating the simulation.

It should be noted that the resolution and posterior covariance are, in general, matrices, The step of comparing the resolution (or posterior covariance) with its threshold may therefore comprise comparing each element of the resolution (or posterior covariance) with a threshold value for that element of the resolution (or posterior covariance), with a “yes” determination being obtained if each element of the resolution (or posterior covariance) is lower than its respective threshold value. Alternatively, the step of comparing the resolution (or posterior covariance) with its threshold may consist of comparing one or more selected elements of the resolution (or posterior covariance) with respective threshold values, rather than performing the comparison for each element of the resolution (or posterior covariance).

The present invention thus allows the performance of a seismic surveying arrangement at a survey location to be evaluated against one or more parameters of AVO uncertainty. The method of FIG. 2(a) provides an iterative process that allows a survey to be designed for which the or each AVO parameter meets a respective design criterion such as, for example, not exceeding a respective pre-determined threshold.

The parameter(s) of AVO uncertainty can be linked to the geologic uncertainty and petro-physical uncertainty of a reservoir at the survey location, provided that a reliable petro-physical model of the survey location is known. If a reliable petro-physical model of the survey location exists, the method of FIG. 2(a) may be extended to derive values for the geologic uncertainty and/or petro-physical uncertainty from the parameter of AVO uncertainty that is obtained at step 11. This provides further information that can be used to evaluate the seismic surveying arrangement.

FIG. 2(b) is a block flow diagram of a further embodiment in which the geologic uncertainty and/or petro-physical uncertainty are estimated from the AVO uncertainty parameter(s). Steps 7 to 13 of FIG. 2(b) correspond to steps 7 to 13 of FIG. 2(a), and the description of these steps will not be repeated.

Once a “yes” determination has been obtained at step 12, a geologic uncertainty parameter and/or a petrophysical uncertainty parameter are determined at step 14. At step 15 the geologic uncertainty parameter and/or the petrophysical uncertainty parameter are compared with a respective design criterion. For example, step 15 may comprise determining whether further the geologic uncertainty parameter and/or the petrophysical uncertainty parameter each fall below a respective pre-determined threshold value. If this comparison step should show that either of the geologic uncertainty or the petrophysical uncertainty parameter does not meet its design criterion (for example if one or both exceeds their respective pre-determined threshold) the parameters of the seismic surveying arrangement are again be adjusted at step 13, and the simulation repeated.

The present invention may be generally applied to the SED phase of any seismic surveys for which prior information such as the noise covariance and/or the model covariance is available, or can be reliably estimated. One particular application of the invention, however, relates to a time-lapse seismic survey at a location where a hydro-carbon reservoir is to be exploited during the period of the survey. When a reservoir is exploited, the seismic properties of the reservoir change. The present invention allows a seismic surveying arrangement to be evaluated against an expected change in the seismic properties of a reservoir as a result of exploitation of reservoir. For example, a seismic surveying arrangement may be evaluated for a model of the survey location that models the reservoir in its current state, and against another model of the survey location that models the reservoir as it is expected to be after a pre-determined period of exploitation. The difference between the two states of the reservoir defines a threshold against which the predicted AVO uncertainty is compared. It is thus possible to check whether a seismic surveying arrangement will meet a pre-determined threshold initially, during and after exploitation of the reservoir.

FIGS. 2(a) and 2(b) illustrate iterative methods that embody the present invention. In these embodiments an initial seismic surveying arrangement is evaluated, and if this is unsatisfactory its parameters are adjusted until a satisfactory arrangement is achieved. The present invention is not, however, limited to such an iterative method. For example, it will be possible to define the parameters of two or more seismic surveying arrangements at step 8, and perform steps 9 and 11 for each of these seismic surveying arrangements. The AVO uncertainty parameters obtained for each of the seismic surveying arrangements can then be compared against one another, and the seismic surveying arrangement having the best value of the uncertainty parameters can be selected.

FIG. 3 illustrates one possible way of displaying the results of a method of the present invention. It illustrates results obtained by performing steps 7 to 11 of the method of FIG. 2(a), as displayed on, for example, a computer monitor.

FIG. 3 shows results for the standard deviation of the change in P-wave velocity at a target interface within the earth's interior. (It should be noted that the term “covariance of AVO parameters” includes the variance of each one and the covariance of each combination of them; the standard deviation is the square root of the variance.) The results were obtained for a particular seismic surveying arrangement, for a particular prior model of the earth's interior at the survey location, and for particular noise and model covariances. The prior model of the earth's interior included overlying interfaces (not shown in FIG. 3), detached salt bodies 24 and the target interface 25. The results for the standard deviation of the change in P-wave velocity at the target interface 25 are displayed as grey-scale coding of the target interface. The scale is in thousands.

It will be seen that the standard deviation of the change in P-wave velocity at the target interface varies spatially over the target interface. In particular it will be noted that the standard deviation is poor in the shadow zones of the salt bodies in the upper left of FIG. 3 and along the slope leading into the basin underneath the salt body on the right of FIG. 3. The seismic surveying arrangement may be modified in light of these results. The invention thus makes it possible to design the seismic surveying arrangement such that this, or any other AVO uncertainty parameter, meets any specified threshold.

FIG. 4 shows an alternative maimer of displaying the results of a method of the present invention. In FIG. 4 the square root of the posterior covariance of three AVO parameters is shown as an ellipsoid for one particular point on the target horizon for one particular surveying arrangement and for particular noise and model covariances. In the FIG. 4 the ellipsoid represents the square root of the posterior covariance of the changes in P-wave velocity, S-wave velocity and density at the target interface. The covariance of these three AVO parameters for a later AVO inversion carried out using the particular surveying arrangement would have a 68% probability, which is the probability of being within one standard deviation, of being within this ellipsoid.

FIG. 5 illustrates an alternative method of displaying the resolution obtained by a method of the present invention. The resolution is an operator and can be represented as a matrix. In FIG. 5, each element of the resolution matrix (here shown as a 3×3 matrix for illustration) is grey-scale coded according to its value. The grey-scale coded values range from −1.0 (black) to +1.0 (white).

From equation (6), the rows of the resolution matrix can be considered filters acting on the true earth model m to give the observed model m_{obs} as deduced from seismic data d. Ideally, if the observed model m_{obs} was identical to the true earth model m the diagonal elements of the resolution matrix would be unity and off-diagonal elements would be zero; using the prior model compensates any deviations (see equation (7)). Hence, the resolution indicates how much of the seismic data will actually be used in arriving at the best solution of a later AVO inversion.

FIG. 6 is a schematic block diagram of an apparatus 16 that is able to perform a method according to the present invention. The user inputs a seismic model of a survey location, parameters of a seismic surveying arrangement and prior information on noise covariance and/or model covariance. The apparatus is able to simulate raypaths of seismic energy, and determine one or more AVO uncertainty parameters such as the resolution and/or posterior covariance according to a method of the invention as described herein.

The apparatus 16 comprises a programmable data processor 17 with a program memory 18, for instance in the form of a read only memory (ROM), storing a program for controlling the data processor 17 to simulate and process seismic data by a method of the invention. The apparatus further comprises non-volatile read/write memory 19 for storing, for example, any data which must be retained in the absence of a power supply. A “working” or “scratch pad” memory for the data processor is provided by a random access memory RAM 20. An input device 21 is provided, for instance for receiving user commands and data. One or more output devices 22 are provided, for instance, for displaying information relating to the progress and result of the processing. The output device(s) may be, for example, a printer, a visual display unit, or an output memory.

The seismic model, the parameters of a seismic surveying arrangement and the prior information may be supplied via the input device 21 or may optionally be provided by a machine-readable data store 23.

The results of the processing may be output via the output device 22, for example by display on a visual display unit as shown in FIGS. 3 and 4, or may be stored.

The program for operating the system and for performing the method described hereinbefore is stored in the program memory 18, which may be embodied as a semiconductor memory, for instance of the well known ROM type. However, the program may well be stored in any other suitable storage medium, such as a magnetic data carrier 18a (such as a “floppy disc”) or a CD-ROM 18b.

1. A method of evaluating a seismic survey, the method comprising the steps of
a) defining a seismic surveying arrangement; and
b) determining one or more parameters of AVO uncertainty from the seismic surveying arrangement at a survey location from a model of the earth's interior at the survey location.

2. A method as claimed in claim 1, wherein step (b) comprises
b1) simulating at least one raypath of seismic energy for the seismic surveying arrangement at the survey location; and
b2) determining one or more parameters of AVO uncertainty from the simulated raypath(s).

3. A method as claimed in claim 2, wherein step (b2) comprises determining one or more parameters of AVO uncertainty using information not obtained from the simulated raypath(s).

4. A method as claimed in claim 2, wherein step (b2) comprises determining one or more parameters of AVO uncertainty using a value for the noise covariance not obtained from the simulated raypath(s).

5. A method as claimed in claim 2, wherein step (b2) comprises determining one or more parameters of AVO uncertainty using a value for the model covariance not obtained from the simulated raypath(s).

6. A method as claimed in claim 1, and comprising the further step of
(c) comparing the value of the or each parameter of AVO uncertainty obtained in step (b) with a respective predetermined threshold for the parameter of AVO uncertainty.

7. A method as claimed in claim 6, and comprising the further step of
(d) adjusting the parameters of the seismic surveying arrangement dependent on the result of the comparing step (c).

8. A method as claimed in claim 7, and comprising the further step of repeating steps (b) and (c) for the adjusted seismic surveying arrangement.

9. A method as claimed in claim 1, wherein the one or more parameters of AVO uncertainty comprise the posterior covariance.

10. A method as claimed in claim 1, wherein the one or more parameters of AVO uncertainty comprise the resolution.

11. A method as claimed in claim 1, and comprising the further step of determining a measure of geologic uncertainty for the survey location from the or each parameter of AVO uncertainty.

12. A method as claimed in claim 11, and comprising the further step of comparing the measure of geologic uncertainty with a pre-determined threshold value.

13. A method as claimed in claim 1, and comprising the further step of determining a measure of petrophysical uncertainty for the survey location from the or each parameter of AVO uncertainty.

14. A method as claimed in claim 13, and comprising the further step of comparing the measure of petrophysical uncertainty with a pre-determined threshold value.

15. An apparatus for evaluating a seismic surveying arrangement, the apparatus comprising means for determining one or more parameters of AVO uncertainty from the seismic surveying arrangement at a survey location from a model of the earth's interior at the survey location.

16. An apparatus as claimed in claim 15, and comprising: means for simulating at least one raypath of seismic energy for the seismic surveying arrangement at the survey location; and means for determining one or more parameters of AVO uncertainty from the simulated raypath(s).

17. AD apparatus as claimed in claim 16, and adapted to determine one or more parameters of AVO uncertainty using information not obtained from the simulated raypath(s).

18. An apparatus as claimed in claim 16, and adapted to determine one or more parameters of AVO uncertainty using a value for the noise covariance not obtained from the simulated raypath(s).

19. An apparatus as claimed in claim 16, and adapted to determine one or more parameters of AVO uncertainty using a value for the model covariance not obtained from the simulated raypath(s).

20. An apparatus as claimed in claim 15, and comprising comparing means for comparing the value of the or each parameter of AVO uncertainty with a respective pre-determined threshold for the parameter of AVO uncertainty.

21. An apparatus as claimed in claim 15, and comprising means for adjusting the parameters of the seismic surveying arrangement dependent on the result of the output from the comparing means.

22. An apparatus as claimed in claim 15, and adapted to determine the posterior covariance as a parameter of AVO uncertainty.

23. An apparatus as claimed in claim 15, and adapted to determine the resolution as a parameter of AVO uncertainty.

24. An apparatus as claimed in claim 15, and adapted to determine a measure of geologic uncertainty for the survey location from the or each parameter of AVO uncertainty.

25. An apparatus as claimed in claim 24, and comprising means for comparing the measure of geologic uncertainty with a pre-determined threshold value.

26. An apparatus as claimed in claim 15, and adapted to determine a measure of petrophysical uncertainty for the survey location from the or each parameter of AVO uncertainty.

27. An apparatus as claimed in claim 26, and comprising means for comparing the measure of petrophysical uncertainty with a pre-determined threshold value.

28. An apparatus as claimed in claim 15, and comprising a programmable data processor.

29. A storage medium containing a program for controlling the data processor of an apparatus as defined in claim 28.

30. A storage medium containing a program for controlling a data processor to perform a method as defined in claim 1.
